(19) United States
(12) Patent Application Publication
(10) Pub. No.: US 2026/0329259 A1
(43) Pub. Date: Oct. 22, 2026

(54) HIERARCHICAL GOVERNANCE SYSTEM AND METHOD FOR CONTROLLED PROGRESSION TOWARD AUTONOMOUS OPERATION IN REGULATED INDUSTRIAL FACILITIES

(71) Applicant: Jae Kwang Park, VERONA, WI (US)

(72) Inventor: Jae Kwang Park, VERONA, WI (US)

(21) Appl. No.: 19/439,338

(22) Filed: Jan. 3, 2026

(51) Int. Cl. G05B 19/418

(52) U.S. Cl. CPC G05B 19/4183; G05B 2219/31328

(57) ABSTRACT

A system and method are disclosed for execution-time governance of control commands in regulated industrial facilities. Control commands issued from an industrial control platform are intercepted before physical actuation and stored in a non-executing state. An operational instability state is determined from process telemetry, and governance constraints are applied to generate a spatially conditional execution boundary associated with a physical asset. Physical execution of a control command is authorized only when a verified physical location of the command-issuing entity satisfies the spatial execution boundary. Execution governance is applied uniformly to human-issued and algorithmically generated commands. In certain embodiments, execution governance is performed on an edge computing device to maintain safety during network disruption. Execution outcomes are recorded in an audit repository to support governance refinement. The disclosed framework provides a deterministic safety layer enabling a controlled progression towards autonomous control sequences while maintaining regulatory compliance.

### CROSS REFERENCE TO RELATED APPLICATIONS

This application is a Continuation-in-Part of, and claims priority to:
(i) U.S. patent application Ser. No. 18/414,566, published as U.S. 2025/0231538, entitled “AI-Driven Optimization and Control of Aeration in Wastewater Treatment Plants in Real Time” (hereinafter “Patent #1”); and
(ii) U.S. patent application Ser. No. 19/437,410, submitted on Dec. 31, 2025, entitled “System and Method for Site-Specific Knowledge Preservation and Validation in Regulated Industrial Facilities Using Adversarial Auditing and Prioritized Retrieval-Augmented Generation” (hereinafter “Patent #2”).
The entire contents of each of the foregoing applications are incorporated herein by reference.

The present disclosure may utilize architectural components, validation mechanisms, and analytical techniques described in the above-referenced applications, including dual-dictionary knowledge structures, adversarial validation processes, and causal analysis and explanation logic, as part of the execution governance framework disclosed herein.

### FIELD OF INVENTION

The present invention relates to industrial control systems and execution safety mechanisms for regulated industrial facilities. More particularly, the invention relates to computer-implemented systems and methods for execution-time governance of control commands, including spatially conditional authorization of physical actuation based on operational state, physical proximity, and validated safety constraints. The disclosed technology is applicable to regulated industrial environments in which safe, reliable, and compliant operation of physical assets is required.

### BACKGROUND OF DISCLOSURE

Modern regulated industrial facilities rely on automated industrial control systems, including Supervisory Control and Data Acquisition (SCADA) systems, Distributed Control Systems (DCS), and Programmable Logic Controllers (PLCs), to monitor and control safety-critical physical processes. Such facilities are subject to stringent regulatory, safety, and reliability requirements and increasingly operate under conditions involving remote supervision, centralized control rooms, and algorithmically assisted decision-making.

While centralized control architectures improve operational efficiency and scalability, they decouple the origin of a control command from the physical environment in which the commanded actuation occurs. As a result, digitally valid control signals may be executed without confirmation that physical conditions at the actuation site are safe at the moment of execution, creating a fundamental technical hazard in regulated industrial environments.

Conventional industrial controllers typically rely on Role-Based Access Control (RBAC) mechanisms that authorize control actions based on authenticated user identity or assigned permissions. Such mechanisms evaluate authorization at login or command issuance but do not condition physical execution on real-time spatial context, verified proximity to a controlled asset, or dynamic operational risk present at the time of actuation. Standard industrial communication protocols lack native support for geospatial or execution-context metadata, preventing controllers from distinguishing between safe control-room commands and potentially hazardous field-level actuations. Furthermore, traditional safety interlocks are generally static and binary, and do not dynamically adjust execution conditions based on evolving process risk.

Accordingly, conventional RBAC-based authorization schemes are insufficient to support safe operation in environments involving remote control, centralized supervision, or emerging autonomous capabilities. Digitally authorized commands may be executed under unsafe physical conditions despite compliance with role-based permission policies, exposing facilities to operational risk, regulatory non-compliance, and safety incidents.

Existing industrial control architectures further fail to leverage historical operational data and institutional knowledge in ways directly relevant to execution-time safety. Although facilities often archive extensive sensor, event, and alarm data, this information is not systematically correlated with command execution outcomes to establish a verified historical basis for determining when and under what conditions physical actuation is safe.

As industrial facilities transition toward greater automation and algorithm-assisted operations, the frequency and volume of control commands are expected to increase. However, conventional algorithmic agents operate primarily within a digital abstraction layer and lack inherent awareness of physical proximity, transient environmental conditions, or execution-time hazards that a human operator might visually verify. This gap limits the safe deployment of advanced automation and autonomous control strategies.

Accordingly, there exists a technical need for a governance system that bridges the gap between conventional manual or SCADA-based control and future autonomous operation. Such a system should mechanically intercept control commands prior to physical actuation and enforce dynamic spatial and operational constraints at execution time, thereby providing a controlled and supervised pathway toward increased automation while maintaining physical safety, accountability, and regulatory compliance.

### SUMMARY OF THE INVENTION

The present invention relates to a spatially conditional execution governance framework for regulated industrial facilities. The framework operates as a supervisory layer between an industrial control platform and physical actuators and is configured to intercept control commands prior to physical actuation. Execution authority is conditioned at actuation time on verified spatial and operational constraints, thereby addressing safety hazards associated with centralized and remote industrial control architectures.

In operation, an intercepted control command is stored in a non-executing state that prevents physical actuation. An operational instability state of the facility is determined based on process telemetry, and a spatial execution boundary associated with a physical asset is generated as a function of the instability state and predefined expert constraints. Physical execution of the control command is permitted only when a verified physical location of the command-issuing entity lies within the spatial execution boundary.

Execution governance is performed at execution time, distinct from user authentication or role-based access control, and is independent of command origin. Identical spatial and operational constraints are applied regardless of whether a control command originates from a human operator or an automated control agent. In certain embodiments, execution governance is performed on an edge computing device local to the facility, thereby maintaining execution safety during loss of external network connectivity. Explicit override conditions may be supported for exceptional circumstances, with such overrides recorded under elevated audit classification.

The invention further provides an execution audit and evidence repository that records authorized and denied execution events together with associated spatial context, instability states, and physical outcomes. Verified execution evidence may be reviewed to refine expert constraints used in generating spatial execution boundaries, while predictive or advisory outputs are prevented from directly triggering physical actuation. The disclosed framework thus provides the technical infrastructure for a controlled and supervised progression toward autonomous operation, wherein autonomy, if permitted, remains permanently bounded by execution-time governance, spatial constraints, and continuous auditability.

### BRIEF DESCRIPTION OF THE DRAWINGS

FIG. 1 illustrates a hierarchical execution governance system architecture for conditioning physical actuation in a regulated industrial facility.

FIG. 2 illustrates an operational instability evaluation module for determining current and predictive process fragility.

FIG. 3 illustrates a spatial execution boundary generator configured to derive a dynamic execution boundary based on operational instability and expert constraints.

FIG. 4 illustrates a spatial verification subsystem for validating physical proximity of a command-issuing entity relative to a controlled asset.

FIG. 5 illustrates a command interception layer configured to prevent direct transmission of control commands to execution-capable hardware.

FIG. 6 illustrates a non-executing command quarantine for isolating intercepted control commands prior to authorization.

FIG. 7 illustrates a command execution controller for authorizing or denying physical actuation based on execution governance conditions.

FIG. 8 illustrates a physical actuation and feedback interface for executing authorized commands and capturing verified execution outcomes.

FIG. 9 illustrates a federated governance constraint integration architecture across multiple industrial facilities.

FIG. 10 illustrates a governance knowledge validation workflow for transforming execution evidence into validated constraints.

FIG. 11 illustrates an evidence structuring and confidence attribution framework for governance knowledge artifacts.

FIG. 12 illustrates a causal analysis and constraint admission subsystem for validating governance constraints prior to application.

FIG. 13 illustrates a heuristic-to-spatial constraint mapping mechanism for translating institutional knowledge into execution boundaries.

FIG. 14 illustrates execution boundary adaptation logic based on verified execution outcomes and operational risk.

FIG. 15 illustrates an execution audit and evidence repository for recording governed execution events.

FIG. 16 illustrates a governed autonomy progression framework for enabling evidence-based transition toward limited autonomous execution.

### DESCRIPTION OF THE INVENTION

### Overview of the Invention

The present invention provides a spatially-conditional governance system operating as a supervisory execution layer in communication with an industrial host platform, enabling a progressive and verifiable transition toward autonomous operation in regulated industrial facilities. The system enforces execution-time governance by intercepting control commands prior to physical actuation and evaluating such commands against geospatial, operational, and contextual constraints before transmission to a physical controller. Authorization of a command is conditioned on verified spatial proximity of the issuing entity to a controlled asset, on a dynamically evaluated operational instability state, and on compliance with validated institutional knowledge applicable to the asset and command context.

### Edge Enforcement and Autonomy Enablement

In certain embodiments, supervisory enforcement is extended to intermittently connected or disconnected environments via an edge-based execution control module configured to locally evaluate authorization conditions independent of centralized connectivity. Execution outcomes—both authorized and denied—together with associated spatial, temporal, and operational metadata, are persistently recorded to generate verified execution datasets. These datasets support incremental refinement of governance policies and serve as ground-truth evidence for the safe evolution of control logic from human-initiated execution toward supervised and ultimately autonomous operation.

### Definitions and Terminology

To facilitate clarity and consistent interpretation of the present disclosure, the following terms are defined for purposes of this specification:
Spatially-Conditional: Logic in which authorization of a control command is dependent upon verified geospatial attributes of the issuing entity relative to a controlled asset, including fixed spatial constraints (e.g., predefined geofences) and adaptive spatial constraints (e.g., dynamically adjusted exclusion or proximity zones), such logic supporting graduated autonomy based on validated spatial compliance.
Governance System: A supervisory control layer configured to intercept, evaluate, and conditionally authorize control commands based on safety, compliance, operational state, and contextual constraints prior to physical actuation, thereby governing transitions from human-initiated to autonomous execution.
Regulated Industrial Facility: A physical site subject to regulatory or compliance requirements imposed by governmental or industry authorities, wherein operations are conducted using industrial control systems. Non-limiting examples include wastewater treatment facilities, electric power generation plants, and chemical processing installations.
Dual-Dictionary Architecture: A bifurcated organizational framework that cross-references a Local Wisdom Dictionary against an International Industry Standard Dictionary to validate site-specific heuristics against global safety and engineering benchmarks.
   Local Wisdom Dictionary: A dynamic repository of validated institutional knowledge, site-specific sensor correlations, and expert heuristics captured from the specific industrial facility.
   International Industry Standard Dictionary: A static or semi-static repository of deterministic safety codes, regulatory mandates (e.g., NPDES, OSHA), and established scientific principles governing the industry at large.
Adversarial Validation: An automated process where a secondary logic unit audits primary outputs for safety or compliance prior to execution, specifically configured to prevent AI hallucinations or “black box” errors.
Causal Analysis and Explanation Logic: Computational processes mapping relationships between input variables and model predictions, including feature importance, causal inference, and counterfactual simulations.
Role-Based Access Control (RBAC): A deterministic access control scheme in which control permissions are assigned to roles and roles are assigned to authenticated identities, such that authorization decisions are computed based on role membership and associated policies.
Execution-Conditional RBAC (EC-RBAC): An authorization scheme in which a control command is permitted to proceed to physical actuation only if (i) a role-based policy permits the command type for the issuing identity and target asset, and (ii) an execution-governance condition is satisfied comprising verified spatial proximity and a risk-adjusted execution boundary.

### Methodology for Technical Description

### Description Format Rationale:

To provide a clear and implementation-ready technical disclosure and to facilitate direct translation of the disclosed embodiments into executable machine logic towards autonomous operation, the following figure descriptions are presented using a modular, element-based bulleted format. This format is selected to:
Support claim mapping, by aligning each bulleted element with a discrete functional component or operational step;
Enable implementation alignment, by defining independent logical units suitable for software development and system integration;
Maintain technical focus, by emphasizing substantive engineering logic while avoiding narrative generalities; and
Improve examination readability, by facilitating efficient cross-referencing between the specification and the drawings

### Detailed Configuration of the Disclosed Architecture

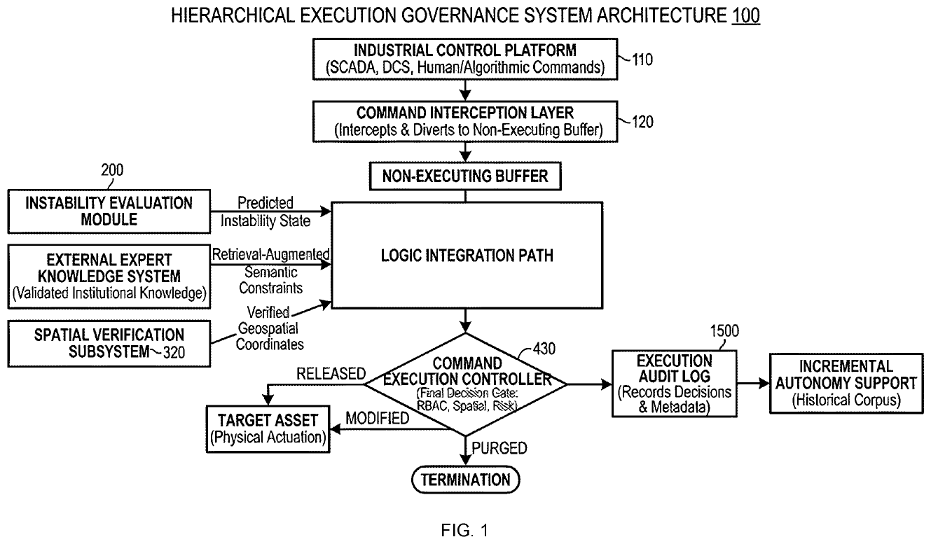

Hierarchical Execution Governance System Architecture 100: FIG. 1 illustrates a representative embodiment of a Hierarchical Governance System 100 establishing the master operational framework integrating predictive optimization, institutional knowledge retrieval, and execution-time governance as a controlled pathway toward autonomy.
System Overview: Establishes a layered supervisory architecture integrating:
   (a) Predictive telemetry and optimization outputs,
   (b) Retrieval-augmented institutional knowledge, and
   (c) Deterministic execution governance. The present invention functions as the final physical execution authority, ensuring that no control command—human- or machine-generated—is actuated without satisfying execution-time safety conditions.
Industrial Control Platform 110:
Represents a SCADA, DCS, or equivalent industrial host platform from which control commands originate, including commands generated by human operators or algorithmic agents.
Command Interception Layer 120:
Intercepts and diverts incoming control commands from the Industrial Control Platform 110 prior to physical actuation and routes such commands to a non-executing buffer, thereby decoupling command issuance from execution.
Logic Integration Path:
Integrates multiple non-executing decision inputs, including:
   (a) a Predicted Instability State derived from the Instability Evaluation Module 200; and
   (b) retrieval-augmented semantic constraints generated by an external expert knowledge system using validated institutional knowledge.
   Importantly, retrieval-augmented generation is used only to derive non-executable governance constraints and does not generate control commands or actuator signals.
Spatial Verification Subsystem 320:
Determines verified geospatial coordinates of the command-issuing entity relative to the target asset.
Command Execution Controller 430:
Serves as the final execution decision gate, evaluating Execution-Conditional RBAC, spatial compliance, and operational risk to determine whether a command is released, modified, or purged.
Execution Audit Log 1500:
Records execution decisions and contextual metadata, forming a verified historical corpus of safe and unsafe execution events used to support incremental autonomy under governance supervision.

This figure establishes a governance layer that separates command issuance from physical actuation, addressing the limitations of conventional centralized control architectures in enforcing execution-time safety constraints.

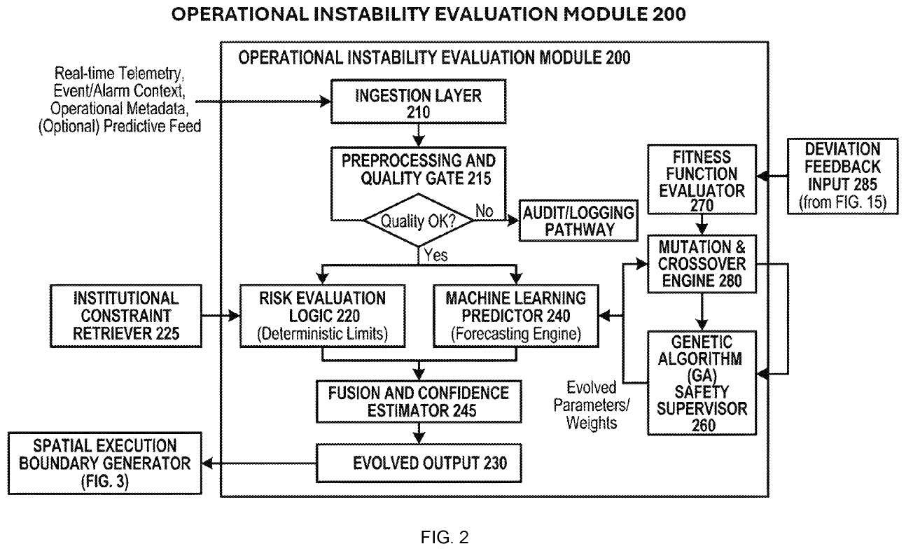

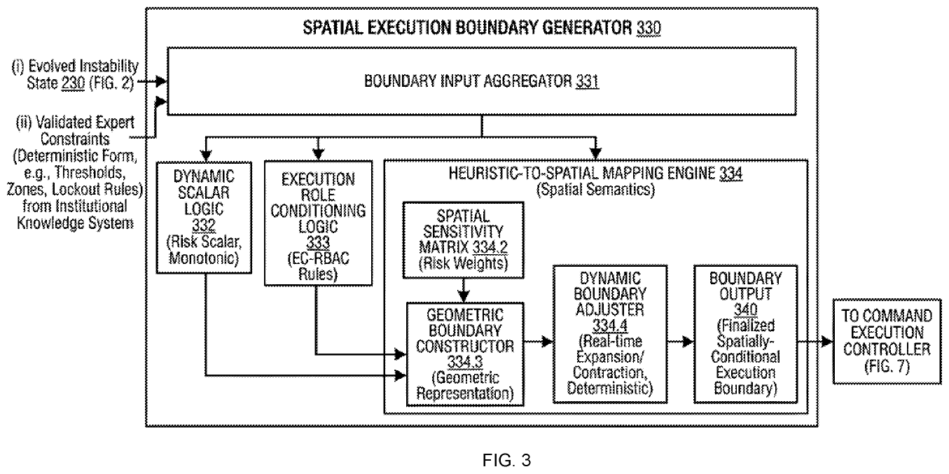

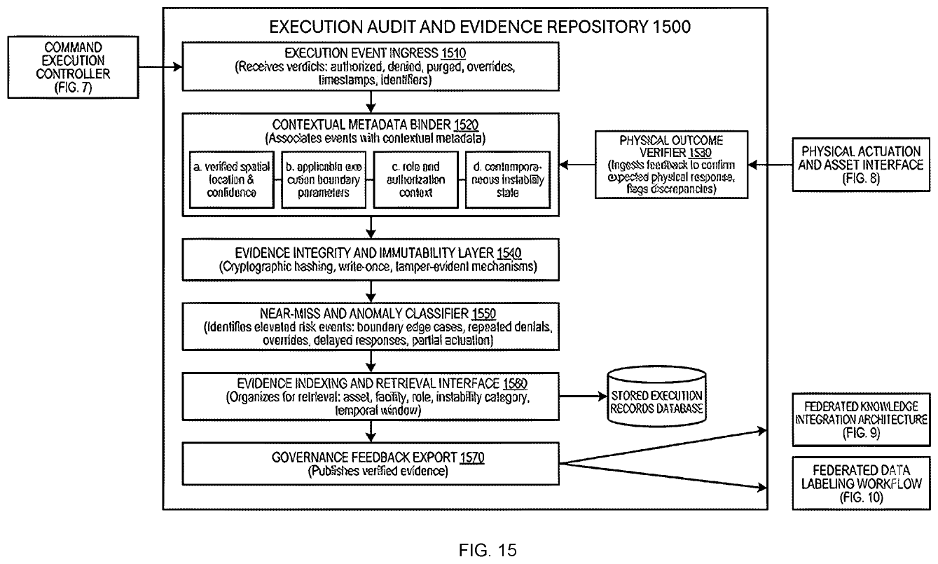

Operational Instability Evaluation Module 200: FIG. 2 illustrates an Instability Evaluation Module 200 configured to compute a non-executable operational instability state used solely to parameterize execution governance (e.g., boundary scaling, lockouts) prior to physical actuation.
Ingestion Layer 210:
Aggregates real-time telemetry, event/alarm context, and operational metadata from the regulated industrial facility. In certain embodiments, the ingestion layer further receives a predictive telemetry feed generated by an external optimization module (e.g., Patent #1) as a non-limiting example of a forecasting input stream.
Preprocessing and Quality Gate 215:
Normalizes, filters, and validates incoming telemetry using signal-quality checks (e.g., missing data detection, sensor plausibility thresholds, drift indicators). Telemetry failing quality criteria is flagged and routed to the audit/logging pathway to prevent unstable or corrupted sensor data from biasing instability estimation.
Risk Evaluation Logic 220 (Deterministic Limits):
Applies deterministic constraints and safety limits (e.g., rate-of-change ceilings, hard min/max bounds, interlock states, maintenance modes) to derive a baseline risk flag set. This module is explicitly non-probabilistic and provides explainable gating signals.
Machine Learning Predictor 240 (Forecasting Engine):
Forecasts a future instability probability or instability trajectory based on current telemetry and historical patterns. Non-limiting examples include LSTM/RNN architectures and related sequence models. This predictor produces advisory risk metrics only and does not generate executable control commands.
Fusion and Confidence Estimator 245:
Combines outputs from Risk Evaluation Logic 220 and the ML Predictor 240 to produce a unified Instability Confidence Vector, including (a) an instability score, (b) a confidence level, and (c) contributing factor indicators used for traceability.
Genetic Algorithm (GA) Safety Supervisor 260:
Executes a controlled search over candidate parameter sets, thresholds, or weighting schemes used by the instability evaluation logic. The GA proposes candidate configurations intended to improve predictive performance under the current facility context while maintaining deterministic safety constraints.
Fitness Function Evaluator 270:
Scores candidate configurations using objective criteria derived from verified outcomes, such as reduced false negatives for instability events, improved early-warning lead time, and adherence to deterministic safety limits. The fitness function may incorporate penalties for unstable behavior, excessive sensitivity, or violation of constraint rules.
Mutation & Crossover Engine 280:
Evolves candidate configurations by iterating weights and rule parameters, using feedback signals derived from execution outcomes and audit logs. This evolutionary process updates evaluation parameters—not actuation decisions.
Deviation Feedback Input 285:
Receives structured deviation feedback derived from the Execution Audit Log (FIG. 15), including false alarms, near-miss patterns, and denied-command contexts. This closes the loop so that the instability evaluator improves over time based on verified physical outcomes.
Evolved Output 230:
Produces a high-confidence Evolved Instability State (e.g., stable/caution/unstable, with confidence bounds) and transmits it to the Spatial Execution Boundary Generator (FIG. 3) as a governance parameter used to scale execution boundaries or trigger lockouts.
Institutional Constraint Retriever 225:
In certain embodiments, deterministic risk limits or context-specific safety envelopes applied in Risk Evaluation Logic 220 may be selected or parameterized using retrieved, validated institutional constraints (e.g., “maintenance mode limits,” “asset-specific safe ramp rates”) obtained from an external expert knowledge system. Any retrieval-augmented generation (RAG) employed by the expert system is used only to surface validated constraints and does not generate executable commands or override the execution decision gate.

This figure allows proactive restriction of execution authority based on forecasted process fragility, overcoming the limitation of static interlocks that respond only after unsafe conditions occur.

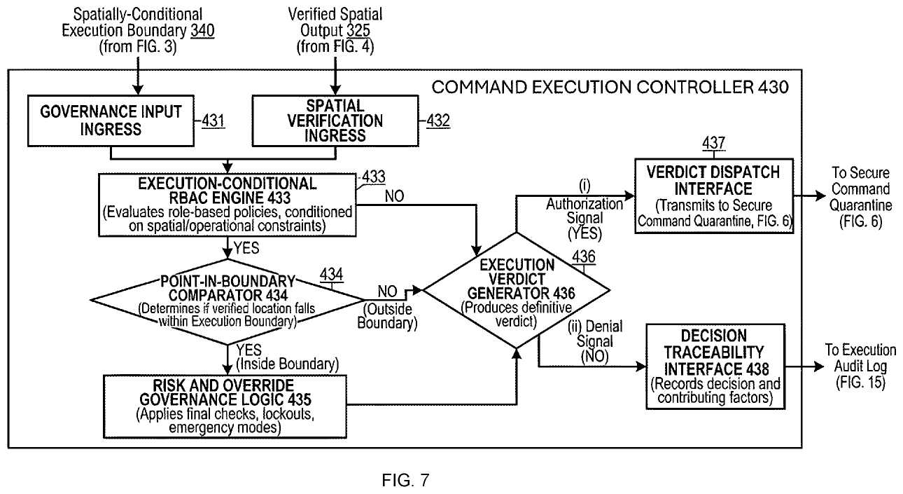

Spatial Execution Boundary Generator 330: FIG. 3 illustrates a Spatial Execution Boundary Generator 330 configured to deterministically compute a risk-adjusted physical execution boundary that governs whether a control command may proceed to actuation, thereby translating predictive and institutional inputs into enforceable execution constraints.
Boundary Input Aggregator 331 (renamed+clarified): Receives non-executable governance parameters, including:
   (a) The Evolved Instability State 230 generated by the Adaptive Instability Evaluation Module (FIG. 2); and
   (b) Validated expert constraints retrieved from an institutional knowledge system. Retrieved constraints may be surfaced via retrieval-augmented generation (RAG) within the expert system, but are provided to the boundary generator only in validated, deterministic form (e.g., thresholds, zones, lockout rules).
Dynamic Scalar Logic 332: Computes a real-time risk scalar as a function of the instability state. The scalar monotonically adjusts execution permissiveness such that decreasing stability results in tighter spatial execution requirements. This logic is deterministic and monotonic, ensuring predictable and auditable behavior.
Execution Role Conditioning Logic 333: Applies Execution-Conditional RBAC (EC-RBAC) rules to the boundary computation, enabling role-dependent spatial constraints. For identical instability states, different roles (e.g., operator, supervisor, maintenance) may result in different execution boundary sizes or execution prohibitions.
Heuristic-to-Spatial Mapping Engine 334: Translates validated expert constraints into spatial semantics by overlaying asset-specific and facility-specific context onto a localized site map. This mapping step converts abstract constraints (e.g., “direct line-of-sight required,” “two-person presence”) into physical proximity requirements without invoking probabilistic reasoning.
Spatial Sensitivity Matrix 334.2: Assigns calibrated risk weights to different physical zones within the facility based on asset criticality, historical incident density, and validated institutional knowledge. The matrix is static or slowly varying and is subject to version control and audit.
Geometric Boundary Constructor 334.3: Deterministically computes the geometric representation (e.g., polygon, polyhedron, or parametric envelope) defining the Spatially-Conditional Execution Boundary, using outputs from the scalar logic, role conditioning logic, and spatial sensitivity matrix.
Dynamic Boundary Adjuster 334.4: Expands or contracts the geometric boundary in real time based on changes in instability state or execution constraints, without altering boundary topology or introducing non-deterministic behavior.
Boundary Output 340: Produces the finalized Spatially-Conditional Execution Boundary and transmits it to the Command Execution Controller (FIG. 7) for execution-time authorization.

This figure converts operational risk and validated institutional knowledge into a physically enforceable execution envelope, addressing the inadequacy of binary enable/disable control logic in safety-critical environments.

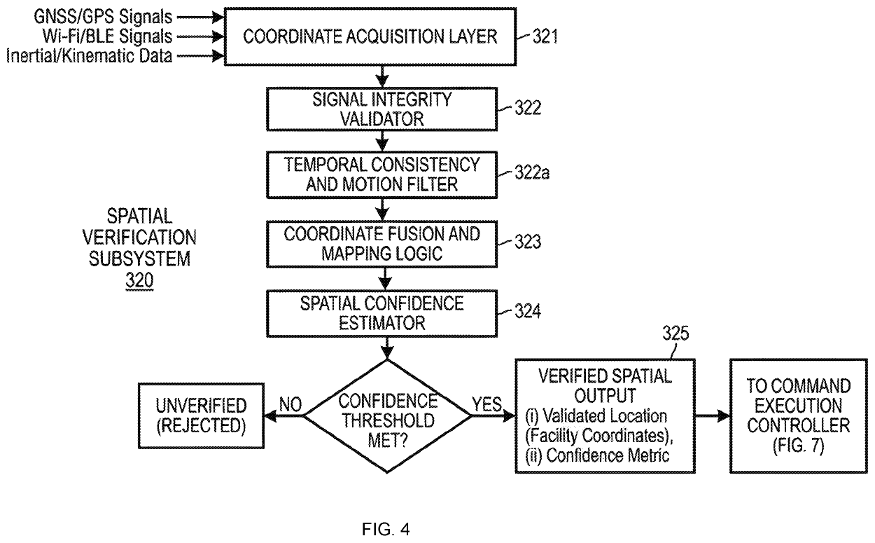

Spatial Verification Subsystem 320: FIG. 4 illustrates a Spatial Verification Subsystem 320 configured to determine a verified, high-confidence physical location of a command-issuing entity relative to a controlled asset, such that execution authorization is conditioned on trusted spatial presence rather than unverified coordinate data.
Coordinate Acquisition Layer 321:
Ingests raw geospatial signals from multiple independent sources associated with the command-issuing terminal. Non-limiting examples include satellite-based positioning signals (e.g., GNSS/GPS), terrestrial radio frequency identifiers (e.g., Wi-Fi SSIDs, Bluetooth Low Energy beacons), and inertial or kinematic sensor data. The subsystem is explicitly designed to operate using multi-source redundancy rather than reliance on a single positioning modality.
Signal Integrity Validator 322:
Evaluates the integrity and plausibility of incoming spatial signals using consistency checks, signal-quality thresholds, and temporal correlation analysis. The validator detects anomalies indicative of spoofing, relay attacks, signal drift, or replay events, and assigns confidence penalties to suspect data streams.
Temporal Consistency and Motion Filter 322a:
Applies time-series analysis to successive coordinate samples to identify physically implausible movement patterns, such as instantaneous displacement, excessive velocity, or inconsistent acceleration, thereby rejecting coordinates that violate physical motion constraints.
Coordinate Fusion and Mapping Logic 323:
Combines validated spatial inputs into a unified location estimate using weighted fusion techniques. The mapping logic converts global or abstract coordinates into a localized facility-specific coordinate system aligned with asset locations, exclusion zones, and execution boundaries defined elsewhere in the governance system.
Spatial Confidence Estimator 324:
Computes a spatial confidence score reflecting the reliability of the fused location estimate, based on signal agreement, integrity checks, and temporal consistency. Location estimates falling below a confidence threshold are flagged as unverified and are ineligible for execution authorization.
Verified Spatial Output 325:
Produces a finalized, high-confidence spatial verification output comprising:
   (a) A validated location estimate within the facility coordinate system; and
(b) An associated confidence metric.

This output is transmitted to the Command Execution Controller (FIG. 7) for comparison against the Spatially-Conditional Execution Boundary.

This figure conditions execution authority on verified physical proximity to a controlled asset, addressing the inability of digital authentication mechanisms to confirm safe physical presence at actuation time.

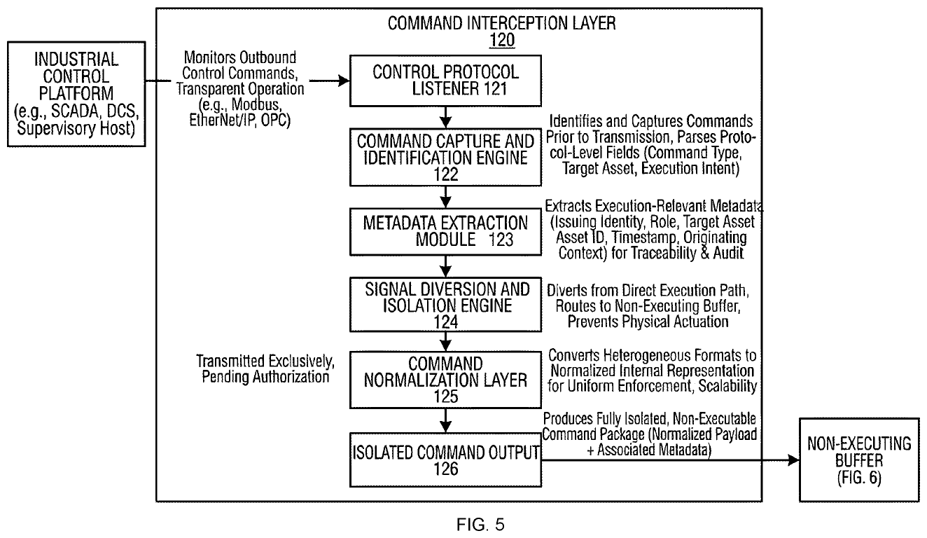

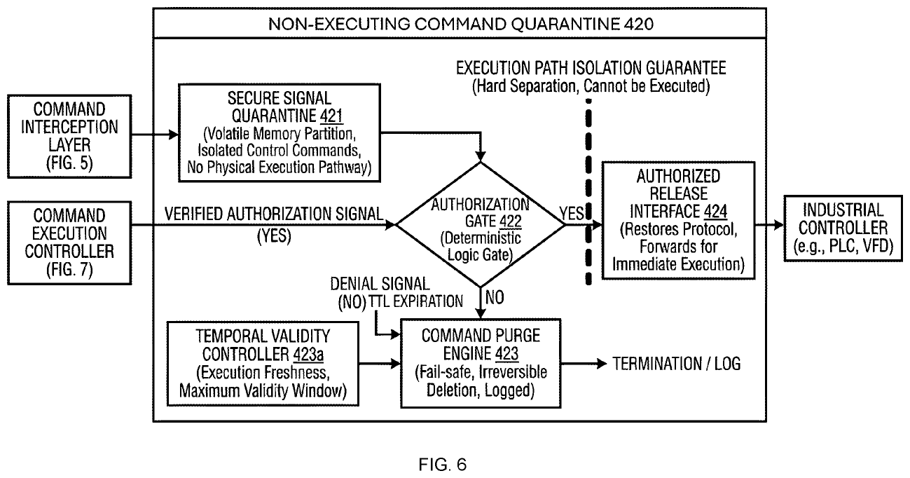

Command Interception Layer 120: FIG. 5 illustrates a Command Interception Layer configured to mechanically decouple command issuance from physical execution by intercepting control signals prior to actuation, thereby ensuring that no control command—whether human-initiated or algorithmically generated—can reach physical equipment without passing execution-time governance.
Control Protocol Listener 121:
Monitors one or more communication interfaces of the Industrial Control Platform (e.g., SCADA, DCS, or supervisory host) to detect outbound control commands destined for physical assets. The listener operates transparently with respect to industrial protocols (e.g., Modbus, EtherNet/IP, OPC), without requiring modification of existing controllers or control logic.
Command Capture and Identification Engine 122:
Identifies and captures detected control commands prior to transmission to a physical controller. This engine parses protocol-level fields to determine the command type, target asset, and execution intent, thereby enabling downstream governance evaluation independent of the command origin.
Metadata Extraction Module 123:
Extracts execution-relevant metadata associated with the captured command, including issuing identity, role designation (for RBAC evaluation), target asset identifier, timestamp, and originating terminal or agent context. This metadata is bound to the command payload for traceability and audit purposes.
Signal Diversion and Isolation Engine 124:
Diverts the captured command away from the direct execution path and routes it to a non-executing buffer, thereby preventing any physical actuation until an explicit authorization verdict is received from the execution governance logic.
Command Normalization Layer 125:
Converts heterogeneous industrial command formats into a normalized internal representation used consistently across governance modules. This normalization enables uniform enforcement of execution constraints across diverse assets and protocols, supporting scalability and the development of future autonomous agents.
Isolated Command Output 126:
Produces a fully isolated, non-executable command package containing the normalized command payload and associated metadata, which is transmitted exclusively to the Non-Executing Buffer (FIG. 6) pending authorization.

This figure intercepts control commands prior to reaching execution-capable devices, preventing circumvention of governance logic inherent in legacy industrial controllers.

Non-Executing Command Quarantine 420: FIG. 6 illustrates a Non-Executing Buffer configured to securely hold intercepted control commands in a non-actuating state while execution-time governance is evaluated, thereby preventing any physical actuation unless an explicit authorization verdict is issued.
Secure Signal Quarantine 421:
A volatile memory partition configured to store isolated control commands received from the Command Interception Layer (FIG. 5). The Secure Command Quarantine is architected such that no physical execution pathway exists between a quarantined command and the controlled hardware unless an explicit authorization signal is asserted.
Execution Path Isolation Guarantee:
The buffer enforces a hard separation between command storage and physical actuation interfaces, ensuring that buffered commands cannot be executed via timing anomalies, protocol fall-through, or software faults. This isolation persists regardless of network state or upstream command source.
Authorization Gate 422:
A deterministic logic gate configured to release a buffered command only upon receipt of a verified Authorization Signal (YES) from the Command Execution Controller (FIG. 7). Absent such authorization, the buffered command remains non-executable.
Command Purge Engine 423:
A fail-safe mechanism configured to irreversibly delete a buffered command upon receipt of a Denial Signal (NO), expiration of a time-to-live threshold, loss of spatial verification confidence, or detection of elevated operational risk. Purged commands are logged but cannot be replayed.
Temporal Validity Controller 423a:
Enforces execution freshness by associating each buffered command with a maximum permissible validity window. Commands not authorized within this window are automatically purged to prevent stale or context-invalid actuation.
Authorized Release Interface 424:
Upon authorization, restores the command to its original or normalized industrial protocol format and forwards it to the Industrial Controller (e.g., PLC, VFD) for immediate execution.

This figure structurally prevents physical actuation by isolating commands in a non-executing state until explicit authorization is granted, eliminating timing, replay, and software-bypass risks.

Command Execution Controller 430: FIG. 7 illustrates a Command Execution Controller 430 configured to serve as the final execution authority that deterministically authorizes, modifies, or denies physical actuation of a control command based on execution-conditional authorization logic, spatial compliance, and operational risk.
Governance Input Ingress 431:
Receives the Spatially-Conditional Execution Boundary 340 generated by the Spatial Execution Boundary Generator (FIG. 3), representing the permissible physical execution envelope for the target asset under current operating conditions.
Spatial Verification Ingress 432:
Receives the Verified Spatial Output 325, including a validated location estimate and associated confidence metric, generated by the Spatial Verification Subsystem (FIG. 4).
Execution-Conditional RBAC Engine 433:
Evaluates role-based authorization policies to determine whether the issuing identity is permitted to issue the specified command for the target asset and command type. Unlike conventional RBAC, this evaluation is performed at execution time and is explicitly conditioned on spatial and operational constraints.
Point-in-Boundary Comparator 434:
Determines whether the verified spatial location of the command-issuing entity falls within the Spatially-Conditional Execution Boundary. If the verified location lies outside the boundary, execution is denied regardless of role-based authorization.
Risk and Override Governance Logic 435:
Applies final governance checks, including elevated instability lockouts, emergency modes, maintenance states, and step-up authorization requirements. Any override conditions are evaluated deterministically and are subject to enhanced audit requirements.
Execution Verdict Generator 436:
Produces a definitive execution verdict comprising either:
(i) an Authorization Signal (YES) permitting release of the quarantined command; or
(ii) a Denial Signal (NO) requiring irreversible purge of the command from the Secure Command Quarantine (FIG. 6).
Verdict Dispatch Interface 437:
Transmits the execution verdict to the Secure Command Quarantine, thereby either enabling controlled release to the industrial controller or triggering purge and denial handling.
Decision Traceability Interface 438:
Records the execution decision, together with contributing factors, including the spatial compliance result, role evaluation outcome, instability state, and applied governance rules, in the Execution Audit Log (FIG. 15). This traceability enables post-hoc review, regulatory audit, and supervised progression toward autonomous operation.

This figure provides a deterministic execution authority that reconciles role-based permissions, spatial compliance, and operational risk, ensuring that no single factor independently authorizes actuation.

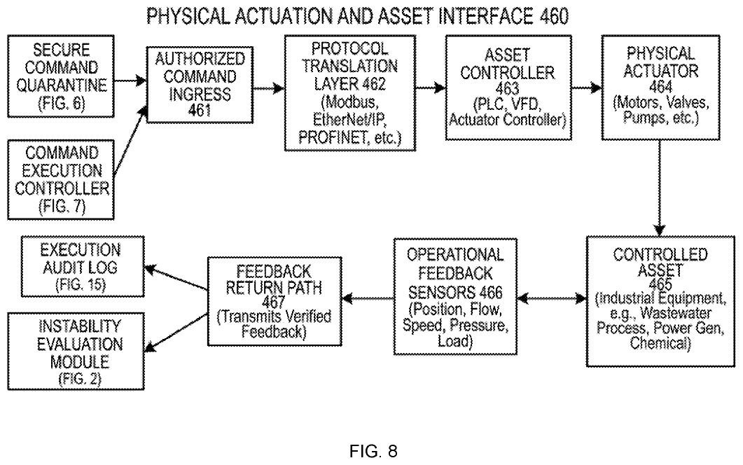

Physical Actuation and Feedback Interface 460: FIG. 8 illustrates a Physical Actuation and Asset Interface 460 configured to execute an authorized control command on a physical industrial asset only after completion of execution-time governance, and to provide verified operational feedback confirming physical actuation.
Authorized Command Ingress 461:
Receives an authorized control command released from the Secure Command Quarantine (FIG. 6) following a positive execution verdict issued by the Command Execution Controller (FIG. 7). Commands not explicitly authorized cannot reach this interface.
Protocol Translation Layer 462:
Translates the authorized command into the specific industrial protocol required by the target asset or controller. Non-limiting examples include Modbus, EtherNet/IP, PROFINET, or vendor-specific fieldbus protocols. This translation preserves command semantics while maintaining compatibility with legacy industrial hardware.
Asset Controller 463:
Represents a local programmable logic controller (PLC), variable frequency drive (VFD), actuator controller, or equivalent embedded control device responsible for applying power or control signals to the physical asset. The asset controller executes only commands received through the authorized interface.
Physical Actuator 464:
The electromechanical or fluidic component that performs the commanded physical action. Non-limiting examples include motors, valves, pumps, breakers, dampers, and drives.
Controlled Asset 465:
The industrial equipment whose operational state is modified by the actuation event. While wastewater process equipment may be referenced in illustrative embodiments, the asset may correspond to any regulated industrial device, including power generation equipment, chemical process units, or manufacturing machinery.
Operational Feedback Sensors 466:
One or more sensors configured to detect and report physical outcomes resulting from the actuation, such as position change, flow variation, speed response, pressure shift, or electrical load change. These sensors provide objective confirmation that the commanded action occurred as authorized.
Feedback Return Path 467:
Transmits verified operational feedback to upstream systems, including the Execution Audit Log (FIG. 15) and the Instability Evaluation Module (FIG. 2), enabling closed-loop validation of execution outcomes.

This figure confirms that only authorized commands result in physical actuation and generates verified feedback linking execution decisions to real-world outcomes.

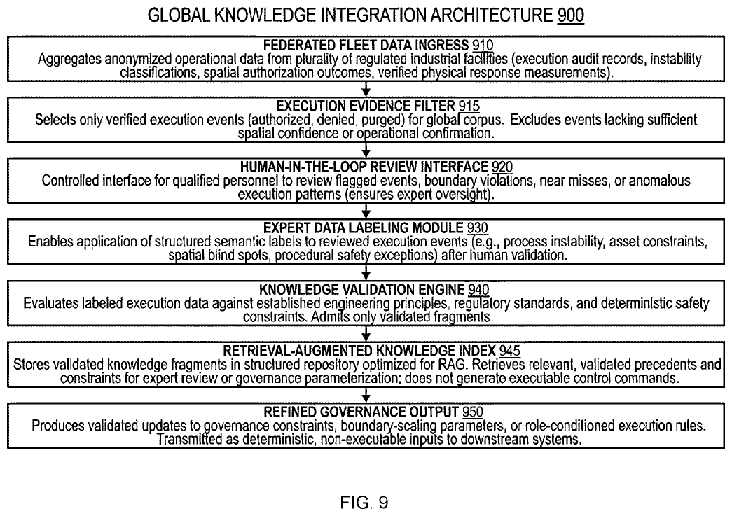

Federated Governance Constraint Integration Architecture: FIG. 9 illustrates an International Industry Standard Integration Architecture 900 configured to aggregate verified execution outcomes, contextual observations, and expert annotations across multiple regulated industrial facilities in order to refine institutional knowledge and governance constraints used to safely progress toward autonomous operation.
Federated Fleet Data Ingress 910:
Aggregates anonymized operational data from a plurality of regulated industrial facilities participating in a federated deployment. Ingested data includes execution audit records, instability classifications, spatial authorization outcomes, and verified physical response measurements resulting from authorized actuation events.
Execution Evidence Filter 915 (important clarification):
Selects only verified execution events—including commands that were authorized, denied, or purged—for inclusion in the International Industry Standard Dictionary. Events lacking sufficient spatial confidence or operational confirmation are excluded to prevent contamination of governance knowledge.
Human-in-the-Loop Review Interface 920:
Provides a controlled interface through which qualified personnel (e.g., operators, engineers, safety reviewers) review flagged events, boundary violations, near misses, or anomalous execution patterns. This interface ensures that institutional knowledge remains grounded in expert oversight rather than autonomous inference.
Expert Data Labeling Module 930:
Permits application of structured semantic labels to reviewed execution events. Non-limiting examples include process instability classifications, asset-specific constraints, spatial blind spots, or procedural safety exceptions. Labels are applied only after human validation.
Knowledge Validation Engine 940:
Evaluates labeled execution data against established engineering principles, regulatory standards, and deterministic safety constraints. Only knowledge fragments passing validation are admitted for downstream use in governance refinement.
Retrieval-Augmented Knowledge Index 945 (proper RAG placement):
Stores validated knowledge fragments in a structured repository optimized for retrieval-augmented generation (RAG). RAG is used solely to retrieve relevant, validated precedents and constraints for expert review or governance parameterization and does not generate executable control commands.
Refined Governance Output 950:
Produces validated updates to governance constraints, boundary-scaling parameters, or role-conditioned execution rules. These updates are transmitted to downstream expert systems and governance modules as deterministic, non-executable inputs.

This figure enables governance refinement based on verified execution evidence across facilities while preserving site-specific constraints through a federated, non-centralized architecture.

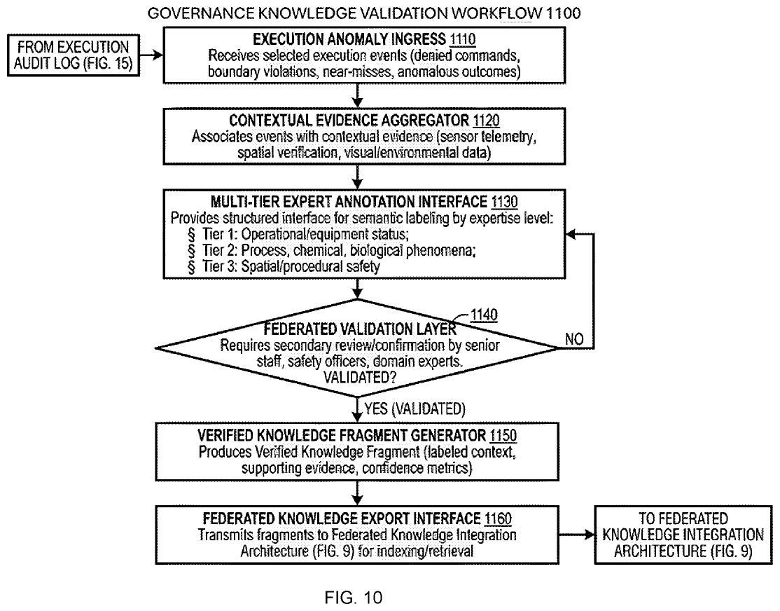

Governance Knowledge Validation Workflow 1100: FIG. 10 illustrates a Federated Data Labeling Workflow 1100 configured to transform verified execution events into validated institutional knowledge through structured expert review, thereby supporting incremental and governed progression toward autonomous operation.
Execution Anomaly Ingress 1110:
Receives selected execution events from the Execution Audit Log (FIG. 15), including denied commands, boundary violations, near-miss events, and anomalous actuation outcomes identified during execution-time governance.
Contextual Evidence Aggregator 1120:
Associates each execution event with contextual evidence, including time-synchronized sensor telemetry, spatial verification metadata, and optional visual or environmental data. This aggregation ensures that expert reviewers evaluate events using physical context, not abstract logs.
Multi-Tier Expert Annotation Interface 1130:
Provides a structured interface enabling qualified personnel to apply semantic labels to execution events. Labeling may be tiered by expertise level, such as:
   Tier 1: Operational and equipment status
   Tier 2: Process, chemical, or biological phenomena
   Tier 3: Spatial or procedural safety considerations
Federated Validation Layer 1140:
Requires secondary review or confirmation by senior technical staff, safety officers, or domain experts prior to acceptance of labeled data. This layer ensures that labeled knowledge reflects validated institutional expertise rather than individual opinion.
Verified Knowledge Fragment Generator 1150:
Produces a Verified Knowledge Fragment comprising the labeled execution context, supporting evidence, and associated confidence metrics. Only fragments passing federated validation are eligible for downstream governance refinement.
Federated Knowledge Export Interface 1160:
Transmits verified knowledge fragments to the Federated Knowledge Integration Architecture (FIG. 9) for indexing, retrieval, and controlled dissemination across participating facilities, while preserving site-specific constraints and data sovereignty.

This figure ensures that institutional knowledge influencing governance logic is derived through structured expert validation rather than unverified algorithmic inference.

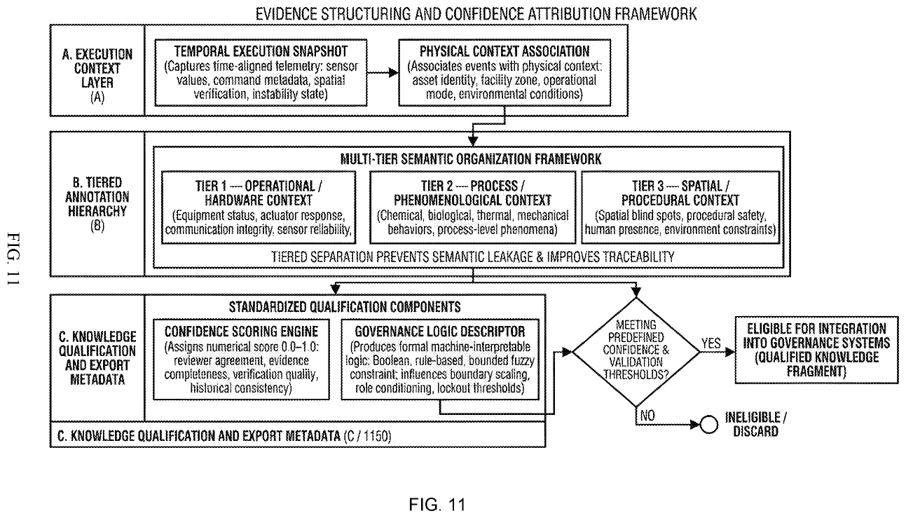

Evidence Structuring and Confidence Attribution Framework: FIG. 11 illustrates an Internal Data Structure and Annotation Hierarchy configured to standardize the organization, scoring, and transformation of execution evidence, contextual information, and expert annotations into validated knowledge suitable for governance refinement and progressive autonomy enablement.
A. Execution Context Layer (A)
   Temporal Execution Snapshot:
   Captures a time-aligned snapshot of execution-relevant telemetry, including sensor values, command metadata, spatial verification results, and instability state at the moment of command authorization or denial.
   Physical Context Association:
   Associates execution events with physical context, such as asset identity, facility zone, operational mode, and environmental conditions, ensuring that annotations are grounded in real-world execution conditions rather than abstract signals.
B. Tiered Annotation Hierarchy (B): Establishes a multi-tier semantic organization framework for expert annotations, enabling structured reasoning without conflating unrelated domains:
   Tier 1—Operational/Hardware Context: Includes equipment status, actuator response, communication integrity, sensor reliability, and maintenance conditions.
   Tier 2—Process/Phenomenological Context: Captures process-level or domain-specific phenomena, such as chemical, biological, thermal, or mechanical behaviors that influence operational stability.
   Tier 3—Spatial/Procedural Context: Encodes spatial blind spots, procedural safety considerations, human presence requirements, and execution-environment constraints not directly observable through standard telemetry.
   This tiered separation prevents semantic leakage between domains and improves traceability of governance decisions.
C. Knowledge Qualification and Export Metadata (C/1150): Standardizes how annotated execution evidence is qualified for downstream use through two primary evaluative components:
   Confidence Scoring Engine: Assigns a numerical Confidence Score to each annotated knowledge fragment, reflecting reviewer agreement, evidence completeness, execution verification quality, and historical consistency. Scores may be expressed on a normalized scale (e.g., 0.0-1.0) and are used to weight governance influence rather than to determine execution outcomes directly.
   Governance Logic Descriptor: Produces a formalized, machine-interpretable logic representation (e.g., Boolean, rule-based, or bounded fuzzy constraint) describing how the validated knowledge fragment may influence execution governance, such as boundary scaling, role conditioning, or lockout thresholds.
   Only knowledge fragments meeting predefined confidence and validation thresholds are eligible for integration into governance systems.

This figure standardizes execution evidence into confidence-qualified knowledge artifacts, addressing the insufficiency of unstructured data for governed reuse.

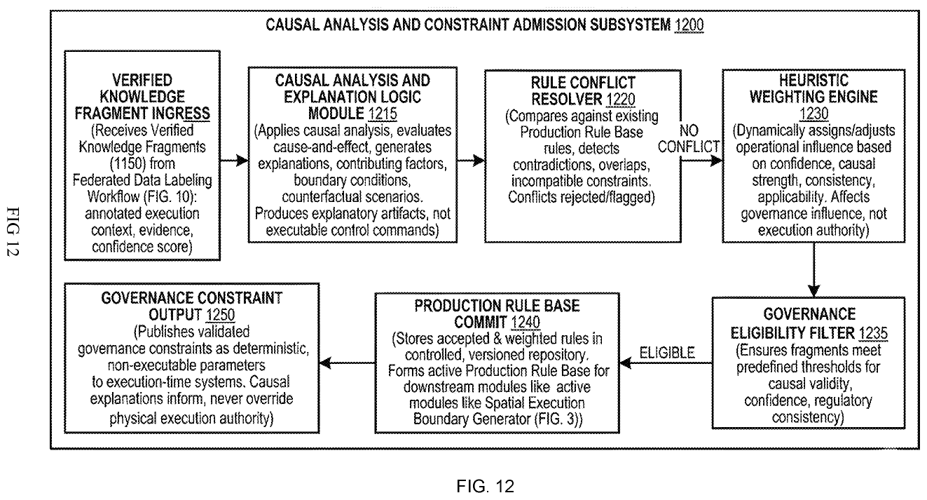

Causal Analysis and Constraint Admission Subsystem 1200: FIG. 12 illustrates a Knowledge Ingress Gateway 1200 configured to admit, validate, weight, and integrate verified knowledge fragments into the governance framework using Causal Analysis and Explanation Logic, thereby ensuring that only causally grounded, non-contradictory knowledge influences execution governance and future autonomy enablement.
Verified Knowledge Fragment Ingress 1210:
Receives Verified Knowledge Fragments (1150) generated by the Federated Data Labeling Workflow (FIG. 10), each fragment comprising annotated execution context, supporting evidence, and an associated confidence score.
Causal Analysis and Explanation Logic Module 1215 (terminology-aligned):
Applies causal analysis techniques to evaluate whether the proposed knowledge fragment exhibits a defensible cause-and-effect relationship between execution conditions and observed outcomes. The module generates structured explanations identifying contributing factors, boundary conditions, and counterfactual scenarios under which the fragment would or would not apply.
Importantly, this logic produces explanatory artifacts, not executable control commands.
Rule Conflict Resolver 1220:
Compares incoming knowledge fragments against existing governance rules stored in the Production Rule Base to detect logical contradictions, unsafe overlaps, or incompatible execution constraints. Conflicting fragments are rejected or flagged for additional expert review.
Heuristic Weighting Engine 1230:
Dynamically assigns or adjusts the operational influence of an accepted knowledge fragment based on its confidence score, causal strength, historical consistency, and applicability to asset class or facility context. Weighting affects governance influence, not execution authority.
Governance Eligibility Filter 1235:
Ensures that only knowledge fragments meeting predefined thresholds for causal validity, confidence, and regulatory consistency are eligible to influence execution governance or autonomy progression.
Production Rule Base Commit 1240:
Stores accepted and weighted governance rules in a controlled, versioned repository forming the active Production Rule Base used by downstream governance modules, including the Spatial Execution Boundary Generator (FIG. 3).
Governance Constraint Output 1250:
Publishes validated governance constraints to execution-time systems as deterministic, non-executable parameters, ensuring that causal explanations inform—but never override—physical execution authority.

This figure prevents incorrect or contradictory knowledge from influencing execution governance by applying causal analysis, confidence qualification, and conflict resolution prior to admission.

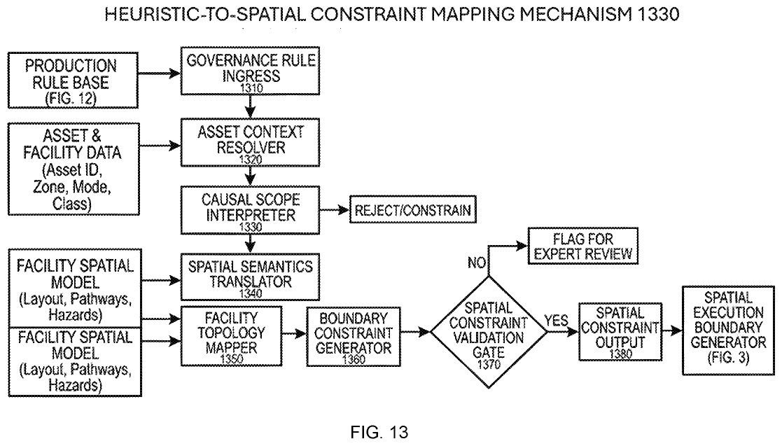

Heuristic-to-Spatial Constraint Mapping Mechanism 1330: FIG. 13 illustrates a Heuristic-to-Spatial Mapping Logic 1300 configured to transform causally validated governance rules into deterministic, asset-specific spatial execution constraints, thereby enabling physical enforcement of institutional knowledge during execution-time governance.
Governance Rule Ingress 1310:
Receives validated governance rules and execution constraints from the Production Rule Base (FIG. 12), each rule having passed causal analysis, confidence qualification, and conflict resolution.
Asset Context Resolver 1320:
Identifies the target asset, associated facility zone, operational mode, and asset class characteristics relevant to the incoming governance rule. This resolver ensures that abstract rules are applied only within appropriate physical and operational contexts.
Causal Scope Interpreter 1330:
Interprets the causal conditions and boundary assumptions associated with each governance rule, including prerequisite states, exclusion conditions, and counterfactual limitations identified during causal analysis. Rules lacking a clear physical scope are rejected or constrained.
Spatial Semantics Translator 1340:
Converts causally scoped governance rules into spatial semantics, such as proximity requirements, exclusion zones, line-of-sight conditions, multi-presence requirements, or restricted approach angles. This translation is deterministic and does not involve probabilistic inference.
Facility Topology Mapper 1350:
Projects spatial semantics onto a facility-specific spatial model, incorporating asset locations, access pathways, visibility constraints, and known hazard zones. The mapper ensures that spatial constraints align with actual physical layouts.
Boundary Constraint Generator 1360:
Produces parameterized spatial constraint definitions suitable for ingestion by the Spatial Execution Boundary Generator (FIG. 3), including geometry modifiers, zone weights, and conditional lockout flags.
Spatial Constraint Validation Gate 1370:
Verifies that generated spatial constraints are internally consistent, non-contradictory, and physically realizable within the facility topology. Invalid or over-constraining outputs are flagged for expert review.
Spatial Constraint Output 1380:
Transmits validated spatial constraints to downstream execution-time governance modules as deterministic, non-executable inputs.

This figure translates validated institutional knowledge into spatial constraints, ensuring that knowledge limits execution authority rather than directly issuing control actions.

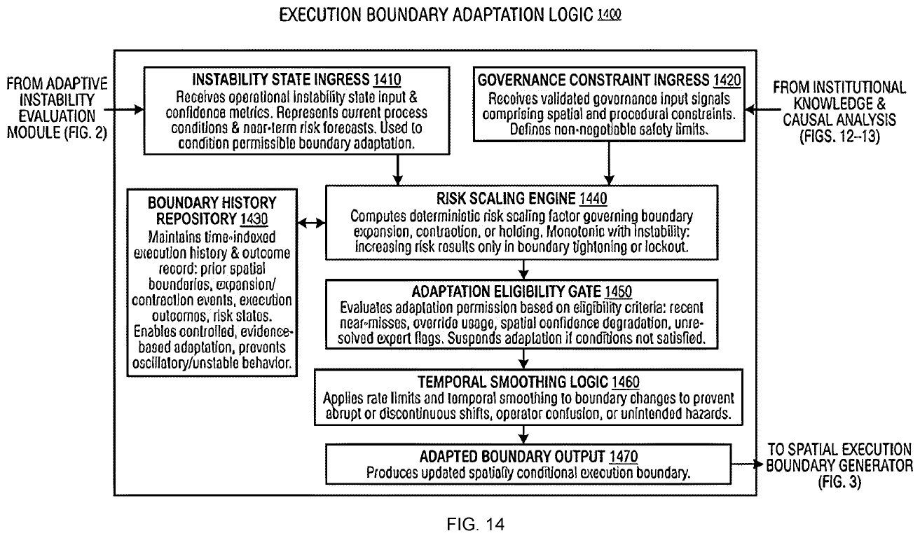

Execution Boundary Adaptation Logic 1400: FIG. 14 illustrates a Boundary Adaptation and Risk Scaling Logic 1400 configured to adjust spatial execution boundaries over time in response to evolving operational risk, verified execution outcomes, and validated governance constraints, while preserving deterministic safety guarantees.
Instability State Ingress 1410:
Receives the current Evolved Instability State and associated confidence metrics generated by the Adaptive Instability Evaluation Module (FIG. 2). This input reflects both present conditions and near-term risk forecasts.
Governance Constraint Ingress 1420:
Receives validated spatial and procedural constraints derived from institutional knowledge and causal analysis (FIGS. 12-13). These constraints define non-negotiable safety limits within which adaptation may occur.
Boundary History Repository 1430:
Maintains a time-indexed record of prior spatial execution boundaries, including expansion and contraction events, execution outcomes, and associated risk states. This repository allows controlled adaptation without oscillatory or unstable behavior.
Risk Scaling Engine 1440:
Computes a deterministic risk scaling factor that governs how aggressively the spatial execution boundary may be expanded, contracted, or held constant. Scaling is monotonic with respect to risk, such that increasing instability results only in boundary tightening or execution lockout.
Adaptation Eligibility Gate 1450:
Evaluates whether boundary adaptation is permitted under current conditions, considering factors such as recent near-miss events, override usage, confidence degradation in spatial verification, or unresolved expert review flags. Adaptation is suspended when eligibility conditions are not met.
Temporal Smoothing Logic 1460:
Applies rate limits and temporal smoothing to boundary changes to prevent abrupt or discontinuous shifts that could confuse operators or introduce unintended hazards.
Adapted Boundary Output 1470:
Produces an updated Spatially-Conditional Execution Boundary and transmits it to the Spatial Execution Boundary Generator (FIG. 3) for use in subsequent execution-time authorization decisions.

This figure governs gradual, monotonic adaptation of execution boundaries based on verified outcomes, preventing unstable or unsafe changes in execution authority.

Execution Boundary Adaptation Logic 1500: FIG. 15 illustrates an Execution Audit Log and Evidence Repository 1500 configured to record, preserve, and structure execution-time decisions and physical outcomes as verifiable evidence supporting accountability, governance refinement, and supervised progression toward autonomous operation.
Execution Event Ingress 1510:
Receives execution verdicts generated by the command execution controller (FIG. 7), including authorized releases, denials, purges, and override events, together with associated timestamps and identifiers.
Contextual Metadata Binder 1520:
Associates each execution event with contextual metadata, including:
   a. verified spatial location and confidence score,
   b. applicable execution boundary parameters,
   c. role and authorization context, and
   d. contemporaneous instability state.
This binding ensures that each event is preserved as a complete execution record rather than an isolated log entry.
Physical Outcome Verifier 1530:
Ingests feedback from the Physical Actuation and Asset Interface (FIG. 8) to confirm whether authorized commands resulted in the expected physical response. Discrepancies between commanded and observed outcomes are explicitly flagged.
Evidence Integrity and Immutability Layer 1540:
Applies integrity protections to stored execution records, including cryptographic hashing, write-once semantics, or tamper-evident mechanisms, ensuring that the audit trail remains reliable for regulatory review and post-incident analysis.
Near-Miss and Anomaly Classifier 1550:
Identifies execution events indicative of elevated risk, including boundary edge cases, repeated denials, override usage, delayed responses, or partial actuation outcomes. These events are prioritized for expert review and labeling.
Evidence Indexing and Retrieval Interface 1560:
Organizes execution records for efficient retrieval based on asset, facility, role, instability category, or temporal window, enabling downstream analysis and federated knowledge integration.
Governance Feedback Export 1570:
Publishes selected, verified execution evidence to the Federated Knowledge Integration Architecture (FIG. 9) and Federated Data Labeling Workflow (FIG. 10), ensuring that only verified execution history informs governance refinement and future autonomy enablement.

This figure preserves immutable execution records linking authorization decisions to physical outcomes, enabling accountability, regulatory review, and evidence-based governance refinement.

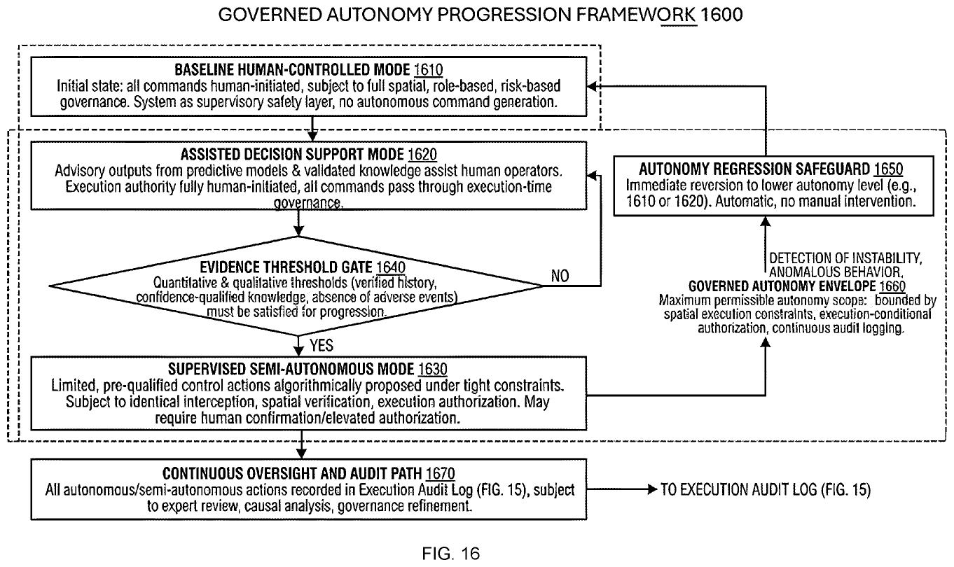

Governed Autonomy Progression Framework 1600: FIG. 16 illustrates a Supervised Autonomy Progression Framework 1600 configured to assist a controlled, reversible, and evidence-driven transition from human-initiated operation toward progressively autonomous execution under continuous governance.
Baseline Human-Controlled Mode 1610:
Represents an initial operational state in which all control commands are human-initiated and subject to full spatial, role-based, and risk-based execution governance. In this mode, the system operates as a supervisory safety layer without autonomous command generation.
Assisted Decision Support Mode 1620:
Introduces advisory outputs derived from predictive models and validated institutional knowledge to assist human operators in decision-making. Execution authority remains fully human-initiated, and all commands continue to pass through execution-time governance prior to actuation.
Supervised Semi-Autonomous Mode 1630:
Permits limited, pre-qualified classes of control actions to be algorithmically proposed under tightly constrained conditions. Such proposed actions are subject to the same interception, spatial verification, and execution authorization as human-issued commands and may require explicit human confirmation or elevated authorization.
Evidence Threshold Gate 1640 (critical addition):
Defines quantitative and qualitative thresholds—derived from verified execution history, confidence-qualified knowledge fragments, and absence of adverse events—that must be satisfied before progression to higher autonomy levels is permitted. Failure to meet thresholds automatically prevents advancement.
Autonomy Regression Safeguard 1650:
Enables immediate reversion to a lower autonomy level upon detection of instability, anomalous behavior, degraded spatial confidence, or regulatory non-compliance. Regression is automatic and requires no manual intervention.
Governed Autonomy Envelope 1660:
Represents the maximum permissible scope of autonomy achievable under the framework, wherein autonomous command generation, if allowed, remains permanently bounded by spatial execution constraints, execution-conditional authorization, and continuous audit logging.
Continuous Oversight and Audit Path 1670:
Ensures that all autonomous or semi-autonomous actions are recorded in the Execution Audit Log (FIG. 15) and remain subject to expert review, causal analysis, and governance refinement.

This figure defines a reversible, evidence-driven pathway for progressively enabling autonomous operation, with execution governance thresholds required to be satisfied.

### INDUSTRIAL APPLICABILITY

Although the detailed description and accompanying figures (FIGS. 1-16) frequently reference wastewater treatment facilities employing activated sludge processes as an illustrative embodiment, such references are exemplary and non-limiting. In such embodiments, optimized control logic derived from Patent #1, including AI-driven aeration control, is provided as input to the disclosed governance architecture. In alternative implementations, the referenced control logic is replaced with facility-specific operational logic and command parameters corresponding to the respective industrial control platform. The spatial verification, adaptive logic mutation, and expert knowledge integration mechanisms described herein support a controlled progression towards autonomous operation across a broad range of regulated industrial environments that require controlled execution boundaries to ensure safe, compliant, and reliable automation.

1. A computer-implemented method for spatially conditional execution governance in a regulated industrial facility, comprising:
(a) intercepting, by an execution governance layer, a control command issued from an industrial control platform prior to transmission to a physical actuator;
(b) storing the intercepted control command in a non-executing memory state that prevents physical actuation;
(c) determining an operational instability state of the regulated industrial facility based on process telemetry;
(d) generating, as a function of the operational instability state and predefined expert constraints, a spatial execution boundary associated with a physical asset;
(e) verifying a physical location of a command-issuing entity relative to the physical asset; and
(f) releasing the control command for physical execution only if the verified physical location lies within the spatial execution boundary.

2. The method of claim 1, wherein generating the spatial execution boundary comprises scaling a geometric perimeter inversely with increasing operational instability.

3. The method of claim 1, wherein increasing operational instability results only in contraction or disabling of the spatial execution boundary.

4. The method of claim 1, wherein the spatial execution boundary is generated relative to asset-specific spatial geometry including access paths, hazard zones, or visibility constraints.

5. The method of claim 1, wherein verifying the physical location comprises fusing multiple positioning signals including satellite-based positioning, terrestrial radio signals, and inertial measurements, and rejecting authorization upon detection of temporal inconsistencies indicative of location spoofing.

6. The method of claim 1, wherein loss of spatial verification confidence results in automatic denial of command execution.

7. The method of claim 1, further comprising recording denied control commands in an execution audit log together with contextual operational data and classifying the denied commands into predefined failure modes including spatial non-compliance and instability-based denial.

8. The method of claim 7, further comprising refining expert constraints used to generate the spatial execution boundary based on accumulated execution audit records.

9. The method of claim 8, wherein refining the expert constraints is performed only after human validation of the execution audit records.

10. The method of claim 8, wherein refined expert constraints are applied as non-executable modifiers to the spatial execution boundary.

11. The method of claim 1, wherein determining the operational instability state comprises processing real-time and historical process telemetry to generate a predictive indication of future process instability used to condition execution governance.

12. The method of claim 11, wherein the predictive indication is generated using one or more predictive analysis tools selected from statistical models, time-series forecasting models, machine learning models, hybrid physics-informed models, or combinations thereof.

13. The method of claim 11, wherein outputs of the predictive analysis tools are prevented from directly triggering physical actuation and are used solely to influence execution boundary generation or execution authorization decisions.

14. The method of claim 1, wherein interception of the control command and evaluation of the spatial execution boundary are performed on an edge computing device local to the regulated industrial facility such that execution governance is maintained during partial or complete loss of external network connectivity.

15. The method of claim 1, wherein the control command is subjected to identical execution governance regardless of whether the command originates from a human operator or an automated control agent.

16. The method of claim 1, further comprising permitting execution of a control command outside the spatial execution boundary only under an explicit override condition, wherein the override condition is recorded with a higher audit classification than non-overridden execution events in the execution audit log.

17. The method of claim 1, wherein the regulated industrial facility comprises one or more of a power generation plant, electric grid facility, food processing plant, refinery, chemical processing facility, pharmaceutical manufacturing facility, or water or wastewater treatment plant.

18. The method of claim 1, wherein the industrial control platform comprises a supervisory control and data acquisition system, a distributed control system, or a programmable logic controller.

19. The method of claim 14, wherein execution governance is selectively performed on a centralized computing system when network reliability metrics satisfy a predefined reliability threshold.

20. The method of claim 1, further comprising enabling progression from human-initiated execution to limited semi-autonomous execution only after satisfaction of predefined evidence, audit, and governance thresholds.
